(19) United States
(12) Patent Application Publication
(10) Pub. No.: US 2002/0020155 A1
(43) Pub. Date: Feb. 21, 2002

(54) Holding plate for the filter bag of a vacuum cleaner

(76) Inventor: Arnoldus Stokmans, Deinze (BE)

Correspondence Address: WILLIAM COLLARD, COLLARD & ROE, P.C., 1077 NORTHERN BOULEVARD, ROSLYN, NY, 11576, US

(21) Appl. No.: 09/813,043

(22) Filed: Mar. 20, 2001

(30) Foreign Application Priority Data
Mar. 20, 2000 (DE) 200 05 448.1

(51) Int. Cl. B01D 46/02

(52) U.S. Cl. 55/373; 55/374

(57) ABSTRACT

A holding plate for the filter bag of a vacuum cleaner has a plug-in opening for attaching a pipe socket of the vacuum cleaner. A seal for sealing the holding plate against the pipe socket of the vacuum cleaner projects into the plug-in opening. In order to lock the holding plate on the pipe socket of the vacuum cleaner, at least one projection pressing the seal against the pipe socket of the vacuum cleaner and projecting into the plug-in opening is provided on the holding plate. In this way, the holding plate is retained on the pipe socket of the vacuum cleaner in a clamped seat.

### BACKGROUND OF THE INVENTION

1. Field of the Invention

The invention relates to a holding plate for the filter bag of a vacuum cleaner.

2. The Prior Art

A holding plate for retaining the filter bag of a vacuum cleaner is disclosed in German Patent No. DE 197 11 611 C2. This holding plate has an opening for plugging in the pipe socket of a vacuum cleaner. A seal projects into the plug-in opening, which assures that the dirt-laden air flowing out from the short pipe socket of the vacuum cleaner only flows through a filter wall of a filter bag attached to the holding plate. The holding plate has a closing flap for sealing the plug-in opening.

In order to safely retain the holding plate in the vacuum cleaner, there is a suitable frame that is adapted to the outer contour of the holding plate. However, this known holding plate has to be fitted into the frame with great precision so as to assure that the holding plate is reliably fixed and centered in relation to the pipe socket of the vacuum cleaner.

### SUMMARY OF THE INVENTION

It is therefore an object of the invention to provide a holding plate for the filter bag of a vacuum cleaner that permits simplified handling of the vacuum cleaner.

This object is accomplished by a holding plate for a vacuum cleaner filter bag having a plug-in opening for a vacuum cleaner pipe socket and a seal projecting into the plug-in opening. There is at least one projection on the holding plate, which presses the seal against the pipe socket of the vacuum cleaner and projects into the plug-in opening and retains the holding plate in a clamped seat on the pipe socket of the vacuum cleaner.

The plug-in opening has a double function in this regard, which is to create an outwardly tight connection between the pipe socket of the vacuum cleaner and a vacuum cleaner filter bag that is retained on the holding plate, and to retain the holding plate on the pipe socket of the vacuum cleaner. To retain the holding plate on the pipe socket of the vacuum cleaner, at least one of the projections protrudes into the plug-in opening. This projection presses the seal, which adapts itself to the contour of the pipe socket, against the pipe socket when it is plugged in, so that the holding plate is retained on the pipe socket of the vacuum cleaner in a clamped seat. This assures that the holding plate is retained adequately safely on the pipe socket of the vacuum cleaner without requiring any further measures such as frames or undercuts for engaging the holding plate. This results in a particularly simple structure of the vacuum cleaner and the holding plate, so that the vacuum cleaner and holding plate can be manufactured at favorable cost.

In order to fix the holding plate on the pipe socket of the vacuum cleaner, the holding plate is simply plugged over the pipe socket so that the socket penetrates the plug-in opening. This causes the seal to be bent by about 90° from the plane of the holding plate against which the projection of the holding plate is pressing. Especially if the pipe socket of the vacuum cleaner has a slightly conical shape, the plugin opening of the holding plate will be automatically centered on the pipe socket, so that simple mounting of the holding plate is assured.

When the filter bag of the vacuum cleaner is filled, the holding plate is simply pulled with little force from the pipe socket of the vacuum cleaner, which cancels the clamping force exerted by the projection. A closing flap is pivot-mounted on the holding plate in order to prevent any undesirable escape of the collected dirt from the filter bag of the vacuum cleaner. In a position of use, the closing flap releases the plug-in opening of the holding plate, so that it will not interfere with the attachment of the holding plate to the pipe socket of the vacuum cleaner or its operation.

The closing flap can be pivoted into a closing position that seals the plug-in opening, so that it prevents dirt from escaping from the filter bag of the vacuum cleaner. In order to retain the closing flap safely in the closing position when the filled filter bag of the vacuum cleaner is transported, the holding plate has at least one projection protruding into the plug-in opening. In the closing position, the projection engages the closing flap from behind. The projection assures safe locking of the closing flap in the closing position and thus safe transport of the filled filter bag of the vacuum cleaner without the risk that dirt may escape from the bag. It is important that the projection approximately opposes the closing flap, so that the outer free end of the closing flap is engaged by the projection. This ensures safe locking of the closing flap in the closing position.

So that the projections will exert force on the pipe socket in as favorable a way as possible, it is advantageous if the projections are uniformly distributed over the circumference of the plug-in opening. Preferably, there are three projections, which are arranged offset against each other by about 120°. This results in a particularly advantageous three-point support that is very stable and will result in good locking of the holding plate on the pipe socket of the vacuum cleaner.

To ensure that the projection will rest against the pipe socket of the vacuum cleaner in the best possible manner, the projection is aligned tangentially in relation to the pipe socket of the vacuum cleaner. Especially if the holding plate is made of cardboard, a slight deformation of the projections will be obtained within the engagement area, so that a flat abutment on the pipe socket of the vacuum cleaner is assured.

The projections are preferably in the form of a semicircle. This will necessarily result in a tangential zone of engagement on the pipe socket of the vacuum cleaner, with the advantages mentioned above. Due to this shape, the holding plate can be safely retained on the pipe socket of the vacuum cleaner even if it is not exactly vertically pushed over the socket because the projections will align the holding plate to a certain extent with the pipe socket of the vacuum cleaner. The projections preferably have the shape of a circular segment that is flat in relation to the radius of the circle, so that with intended deformability of the projections in the engagement area of the pipe socket of the vacuum cleaner, the shape of the projection is nonetheless dimensionally stable in all other respects.

Especially with a soft pipe socket, the projection preferably has a tapered shape. This reduces the area of engagement of the projection on the pipe socket of the vacuum cleaner. However, the socket will be slightly deformed in an elastic manner, which improves the arrest of the holding plate on the pipe socket accordingly. In particular, the idea is to provide the projection that secures the closing flap in its closing position with a tapered form. It is thus possible to press the closing flap behind the tapered projection, which, because of its elastic resetting force, will then assume again its original position and reliable lock the closing flap.

To improve the locking of the holding plate on the pipe socket of the vacuum cleaner, the projection has teeth within the zone of engagement of the pipe socket of the vacuum cleaner. When the holding plate is pressed onto the pipe socket of the vacuum cleaner, the teeth are deformed to an extent such that safe locking of the holding plate is assured.

If the holding plate is made of relatively thick cardboard, the projections have relatively low elasticity or deformability. In this case, it is advantageous if the projections are provided with at least one cut approximately extending in the peripheral direction toward the plug-in opening. Such a cut can be produced in a very simple way during the punching process for producing the holding plate, without any additional working step. This cut assures in the simplest manner that the elasticity and the deformability of the projection are enhanced to the required extent.

The holding plate according to the invention is safely retained with its plug-in opening on the pipe socket of the vacuum cleaner, so that additional measures for locking the holding plate can be eliminated. It is therefore possible to retain the holding plate on the pipe socket of the vacuum cleaner exclusively by its plug-in opening. Frames or similar measures for holding the holding plate in the correct position can be omitted, so that the vacuum cleaner can be manufactured at favorable cost and the holding plate can be mounted in a simple way.

When the holding plate is placed on the pipe socket of the vacuum cleaner, the seal retained on the holding plate is pressed in the direction of the filter bag of the vacuum cleaner. To achieve good locking of the holding plate on the pipe socket of the vacuum cleaner, it is sufficient if the projections are arranged on the side of the filter bag facing the seal, so that they are capable of pressing against the seal. This means that the seal is arranged between the projection and the pipe socket of the vacuum cleaner, so that the static friction caused by the seal can be exploited for locking the holding plate.

The projection locking the closing flap in its closing position is preferably located on the side of the seal facing away from the filter bag. This means that the closing flap has to be pressed only behind the projection, but not behind the seal, which simplifies the closing of the plug-in opening of the holding plate accordingly.

If the holding plate is has several layers, the seal is usually arranged between the layers. In such a case, the projection is provided in only one of the layers. The projections are preferably located on the layer on the side of the filter bag, whereas the projection for locking the closing flap is located in the layer supporting the closing flap.

The closing flap is preferably pivot-mounted on the holding plate via a perforation, a partial cut or a bulging fold. In this way, the closing flap can be produced together with the holding plate as one piece, so that the components do not need to be assembled in a complicated manner in their correct positions. Furthermore, the closing flap is set free from the holding plate by a cut, so that it can swing freely.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a perspective view of a vacuum cleaner filter bag with a holding plate;

FIG. 2 is a sectional view with a cut through the holding plate according to FIG. 1 shown in the installed position;

FIG. 3 is a top view of the holding plate according to FIG. 1;

FIG. 4 shown an alternative embodiment of the holding plate according to FIG. 3; and

FIG. 5 shows another alternative embodiment of the holding plate according to FIG. 3.

### DETAILED DESCRIPTION OF THE PREFERRED EMBODIMENT

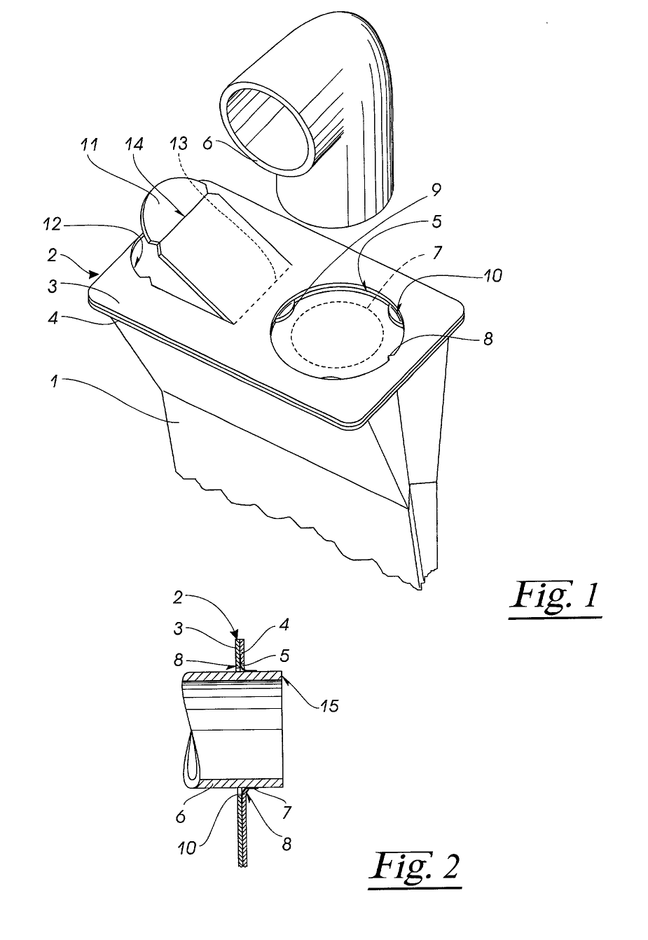

Referring now in detail to the drawings, FIG. 1 shows a perspective view of a filter bag 1 of a vacuum cleaner, with a holding plate 2 glued to the filter bag. Filter bag 1 comprises a number of layers of a filter paper that is permeable to air, whereas the holding plate 2 is formed by the two layers 3 and 4 of a relatively dimensionally stable cardboard. Layers 3 and 4 are joined with each other as one piece along one edge and otherwise glued to one another. Holding plate 2 has a plug-in opening 5 that penetrates the two layers 3 and 4. When holding plate 2 is in its mounted position, plug-in opening 5 is penetrated by a pipe socket 6 of the vacuum cleaner. Air laden with dirt flows into filter bag 1 via pipe socket 6.

Pipe socket 6 may have a cylindrical shape or it may be slightly conical, tapering toward the free end. To obtain an outwardly tight connection between pipe socket 6 and filter bag 1 of the vacuum cleaner, there is a seal 7 on holding plate 2. Seal 7 is indicated only by a dashed line for the sake of better visibility of the components of holding plate 2 located underneath.

Holding plate 2 has projections 8, 9 projecting into plug-in opening 5, whereby projection 8 is molded onto the top (or cover) layer 3 and projections 9 are molded onto the layer 4 located on the side of the filter bag. The three projections 9 in layer 4 on the side of the filler bag are uniformly distributed over the circumference of the plug-in opening 5 and enclose an angle of 120° between each other. When holding plate 2 is mounted on pipe socket 6 of the vacuum cleaner, projections 9 press seal 7 against pipe socket 6 of the vacuum cleaner in order to lock holding plate 2. So as to assure that projections 9 are adequately elastic, they are penetrated by a cut 10 extending in the peripheral direction towards plug-in opening 5. Cut 10 weakens projections 9 accordingly and makes it easier to fold the them over when pipe socket 6 of the vacuum cleaner penetrates.

A closing flap 11 is released from the cover or top layer 3 by a cut 12 and is connected with cover layer 3 via a perforation 13, forming one piece with layer 3. The closing flap 11 is pivot-mounted along the perforation 13 and can be swivelled from a position of use located in the plane of cover layer 3, into a closing position, in which closing flap 11 seals plug-in opening 5.

In order to retain closing flap 11 in its closing position, it is pressed behind projection 8 which, because of its elastic resetting force, subsequently resumes the position shown in FIG. 1, in the plane of the cover layer 3. Closing flap 11 is safely retained in the closing position in this way, so there is no risk of dirt escaping from filter bag 1 of the vacuum cleaner during transport. To safely close plug-in opening 5, closing flap 11 has a partial cut 14 extending parallel with perforation 13. Partial cut 14 extends only over part of the thickness of cover layer 3. This allows closing flap 11 to bend about folding line 14, so that closing flap 11 can be swivelled by slightly more than 180° and engage projection 8 from behind without bending through.

FIG. 2 shows a sectional representation with a cut through holding plate 2 in the installed position. Seal 7 folds over along the outer surface of pipe socket 6 of the vacuum cleaner in the direction of free end 15 of pipe socket 6 and rests flatly against pipe socket 6. This is important for producing an airtight connection between pipe socket 6 and filter bag 1 of the vacuum cleaner. Projection 9 is slightly deformed and bent in the direction of free end 15 of pipe socket 6 when holding plate 2 is in its installed position. Projection 9 presses against seal 7, so that seal 7 is pressed against pipe socket 6 of the vacuum cleaner with greater force. In this way, the static friction of seal 7 on pipe socket 6 is advantageously exploited for locking holding plate 2 on pipe socket 6 of the vacuum cleaner.

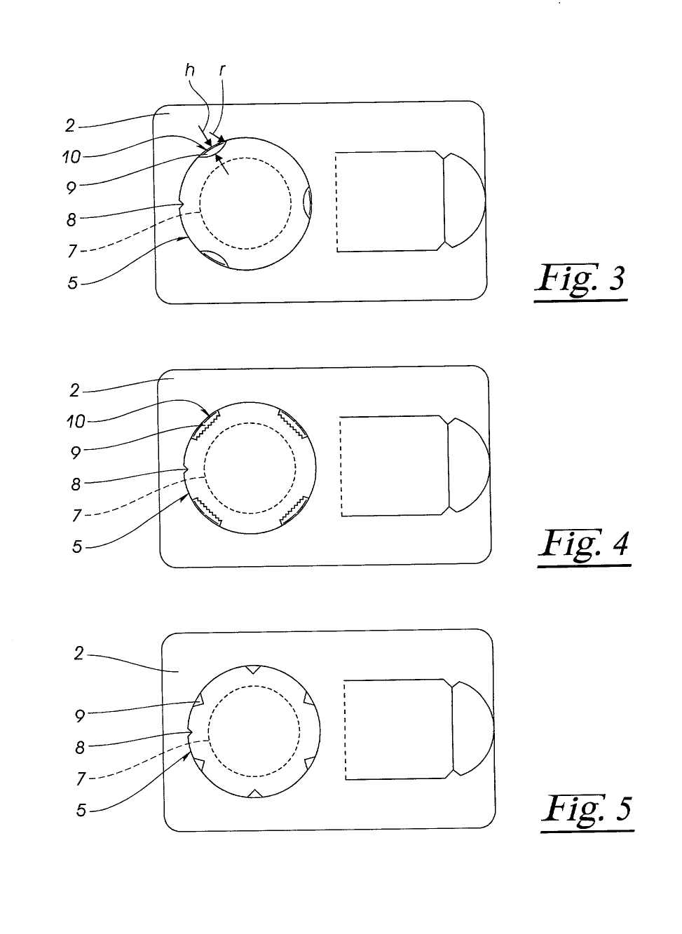

FIG. 3 shows a top view of holding plate 2, whereby the seal 7 is indicated again by a dashed line. In the present embodiment, the three projections 9 have the shape of a semicircle, so that projections 9 rest tangentially against pipe socket 6 of the vacuum cleaner. The height “h” of the semicircle is substantially smaller than its radius “r”, so that projection 9 has a substantially greater expanse in the peripheral than in the radial direction. This provides for adequate elasticity of projection 9 where it rests against pipe socket 6. Projection 9 is nonetheless strong in all other respects. To obtain sufficient elasticity of projections 9, they are penetrated by cuts 10. Alternatively, cuts 10 can be omitted depending on the strength of holding plate 2. On the other hand, each projection 9 could have more than one radial cut 10, or the number of projections could be adapted to the given requirements.

Projection 8 provided in top layer 3 is substantially smaller than projections 9 provided in layer 4 on the side of the filter bag. Projection 8 locks closing flap 11 in its closing position and it is tapered for this purpose toward the center of plug-in opening 5.

FIG. 4 shows an alternative embodiment of holding plate 2, whereby projections 9 are trapezoidal and provided with the teeth 16 within the zone of engagement of pipe socket 6 of the vacuum cleaner. As opposed to the embodiment according to FIG. 3, there are four projections 9, which are offset against each other by about 90°. Projections 9 each are penetrated by the two cuts 10 in order to increase their elasticity. The number of cuts 10 or the number of projections 9 can be adapted to the given requirements in conjunction with the present embodiment as well.

Finally, FIG. 5 shows another alternative embodiment of holding plate 2 with six projections 9. Projections 9 are tapered toward the center of plug-in opening 5 and in this way achieve an approximately punctiform support on pipe socket 6 of the vacuum cleaner. The number of projections 9 can be increased or reduced in connection with the present embodiment as well, depending on the requirements with respect to the holding strength of the holding plate.

Accordingly, while only a few embodiments of the present invention have been shown and described, it is obvious that many changes and modifications may be made thereunto without departing from the spirit and scope of the invention.

What is claimed is:

1. A holding plate for a filter bag of a vacuum cleaner having a pipe socket, said holding plate comprising:
a plug-in opening for the pipe socket;
a seal projecting into the plug-in opening, and
at least one projection on the holding plate, said projection projecting into the plug-in opening and adapted to press the seal against the pipe socket of the vacuum cleaner to retain the holding plate in a clamped seat on the pipe socket of the vacuum cleaner when said holding plate is mounted on the vacuum cleaner.

2. The holding plate according to claim 1, further comprising a closing flap pivot-mounted on said holding plate, said closing flap is pivotable from a position of use, in which the plug-in opening is released, into a closing position sealing said plug-in opening, and wherein said at least one projection is located approximately opposite the pivot of said closing flap and projects into the plug-in opening, and is engaged from behind by the closing flap in the closing position for locking said closing flap.

3. The holding plate according to claim 1, wherein said at least one projection comprises several projections uniformly distributed over the circumference of the plug-in opening.

4. The holding plate according to claim 1, wherein said at least one projection extends tangentially in relation to an engagement area of the pipe socket of the vacuum cleaner when said holding plate is mounted to the vacuum cleaner.

5. The holding plate according to claim 4, wherein said at least one projection has the shape of a divided circle.

6. The holding plate according to claim 1, wherein said at least one projection tapers in the direction of the pipe socket of the vacuum cleaner when said holding plate is mounted to the vacuum cleaner.

7. The holding plate according to claim 1, wherein said at least one projection is fitted with teeth in an area that engages the pipe socket when said holding plate is mounted to the vacuum cleaner.

8. The holding plate according to claim 1, wherein said at least one projection has at least one cut.

9. The holding plate according to claim 1, wherein when the holding plate is mounted to the vacuum cleaner, the holding plate is retained on the pipe socket of the vacuum cleaner exclusively via said plug-in opening.

10. The holding plate according to claim 1, wherein said at least one projection is disposed only between the seal and the filter bag of the vacuum cleaner,

11. The holding plate according to claim 1, wherein said at least one projection is disposed only on a side of the seal facing away from the filter bag of the vacuum cleaner.

12. The holding plate according to claim 10, wherein the holding plate comprises several layers with said seal being disposed between two of said layers, and wherein said at least one projection is disposed in only one of the layers.

13. The holding plate according to claim 2, wherein said closing flap is pivotably connected with the holding plate via one of a perforation, a cut extending over only part of the thickness of the closing flap, and a bulging fold.
